(19) United States
(12) Patent Application Publication
(10) Pub. No.: US 2013/0100432 A1
(43) Pub. Date: Apr. 25, 2013

(54) LASER RANGEFINDER WITH SINGLE SHUTTER

(71) Applicant: Nen Tsua Li, Taichung City (TW)

(72) Inventor: Nen Tsua Li, Taichung City (TW)

(21) Appl. No.: 13/276,320

(22) Filed: Oct. 19, 2011

(51) Int. Cl. G01C 3/00

(52) U.S. Cl. 356/3

(57) ABSTRACT

A laser rangefinder with single shutter includes a body and a laser-radiating board. The body has a transmitting gateway and a receiving gateway. A shutter is mounted in the transmitting gateway. The body has an adjusting gateway communicating with the transmitting gateway and the receiving gateway. The laser beam is radiated to the object via the transmitting gateway and the shutter. When the object receives the laser beam, the laser beam is reflected into the receiving gateway by the object and the laser beam goes through the receiving gateway to the laser-radiating board thereafter the laser-radiating board calculates the actual distance from the laser rangefinder with single shutter to the object. Furthermore, the adjusting gateway prevents the laser beam interfering in the operating of the laser-radiating board and the laser beam is reflected by the shutter to the laser-radiating board via the adjusting gateway for calculating a reference distance.

### BACKGROUND OF THE INVENTION

1. Field of the Invention

The present invention relates to a laser rangefinder, and more particularly to a laser rangefinder with single shutter.

2. Description of Related Art

A conventional laser rangefinder is a device which uses a laser beam to determine the distance to an object with the time of flight principle. The conventional laser rangefinder sends a laser beam towards the object, and then measures the time interval between the laser beam emitting from the conventional laser rangefinder and reflected back from the object to the conventional laser rangefinder. The conventional laser rangefinder comprises a body, a transmitting gateway, a receiving gateway, an adjusting gateway, a laser-radiating board and two shutters. The transmitting gateway and the receiving gateway are set up in the body. The transmitting gateway is parallel with the receiving gateway. The adjusting gateway communicates with the transmitting gateway and the receiving gateway. The angle between the adjusting gateway and the receiving gateway is usually 90 degrees or other specific angle. The laser-radiating board is mounted to one end of the body and corresponding to the transmitting gateway and the receiving gateway. The laser beam is emitted from the laser-radiating board to the transmitting gateway during operating. One shutter is mounted for interdicting the transmitting gateway and another shutter is mounted for interdicting the adjusting gateway. When the laser beam is directly emitted to the object for measuring the distance to the object, one shutter opens for transmitting the laser beam out and another shutter closes for preventing the laser beam from scattering into the adjusting gateway; when the conventional laser rangefinder is under adjusting, one shutter closes for reflecting the laser beam toward the adjusting gateway and another shutter opens for guiding the laser beam into the adjusting gateway. However, the conventional laser rangefinder has two shortcomings as following:

First, when the two shutters switch at the same time, the conventional laser rangefinder is vibrating slightly instead of stable; and

Second, the structure of the conventional laser rangefinder with two shutters is too complicated and it might cost a lot of time to produce the conventional laser rangefinder.

Thus, how to simplify the structure of the conventional laser rangefinder with two shutters is an important issue.

The present invention has arisen to mitigate and/or obviate the disadvantages of the conventional. Further benefits and advantages of the present invention will become apparent after a careful reading of the detailed description with appropriate reference to the accompanying drawings.

### SUMMARY OF THE INVENTION

The main objective of the present invention is to provide an improved laser rangefinder.

To achieve the objective, a laser rangefinder with single shutter comprises a body and a laser-radiating board, the body having a transmitting gateway and a receiving gateway defined inside thereof, the transmitting gateway being parallel to the receiving gateway, a shutter mounted on the transmitting gateway, the body having an adjusting gateway, the adjusting gateway communicates with the transmitting gateway and the receiving gateway, the laser-radiating board mounted to one end of the body and corresponding to the transmitting gateway and the receiving gateway, to close the shutter or to open the shutter is used to interdict the laser beam from the laser-radiating board or not, a mat structure is formed on the inside wall of the adjusting gateway, a rugged structure is formed on the inside wall of the adjusting gateway, a thread structure is formed on the inside wall of the adjusting gateway, an optical fiber structure or other light guiding structure is formed on the inside wall of the adjusting gateway, the transmitting gateway is curve shape, an optical fiber structure which has a predefined reflecting surface is formed on the inside wall of the adjusting gateway, the optical fiber structure which has the predefined reflecting surface is formed on the inside wall of the adjusting gateway.

Wherein the laser beam from the laser-radiating board is emitted to the object via the transmitting gateway and the shutter; when the laser beam travels to the object, the laser beam is reflected back to the receiving gateway by the object and the laser beam goes through the receiving gateway to the laser-radiating board, thereafter the laser-radiating board calculates an actual distance from the laser rangefinder with single shutter to the object; when the shutter opens, the adjusting gateway prevents the laser beam in the transmitting gateway from scattering to the laser-radiating board to interfere in the operating of the laser-radiating board; when the shutter closes, the laser beam is reflected by the shutter to the laser-radiating board via the adjusting gateway so that the laser-radiating board calculates the reference distance from the distance-operating database.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a laser rangefinder with single shutter of the present invention;

FIG. 2 is another perspective view for showing a laser-radiating board mounted to one end of a body;

FIG. 3 is a top plan view of the present invention;

FIG. 4 is an assembled view for showing the laser rangefinder with single shutter which is under operating;

FIGS. 5-6 are assembled views for showing the second embodiment of the present invention; and

FIGS. 7-8 are assembled views for showing the third embodiment of the present invention.

### DETAILED DESCRIPTION OF THE INVENTION

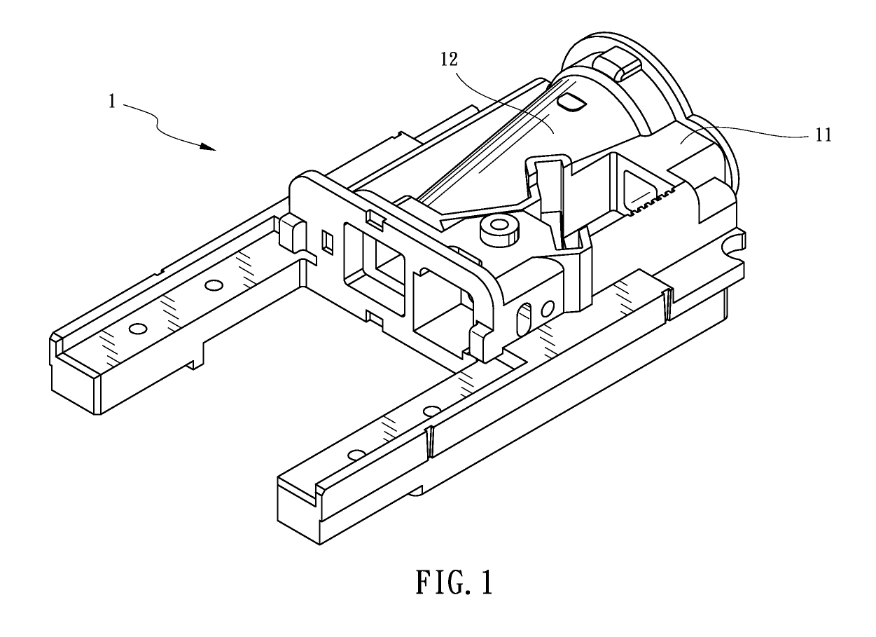

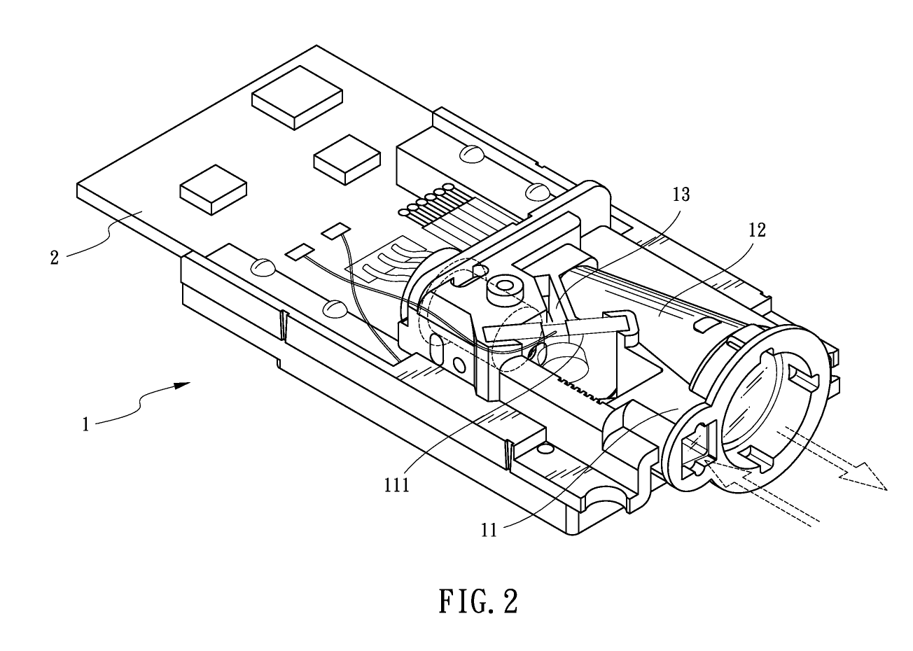

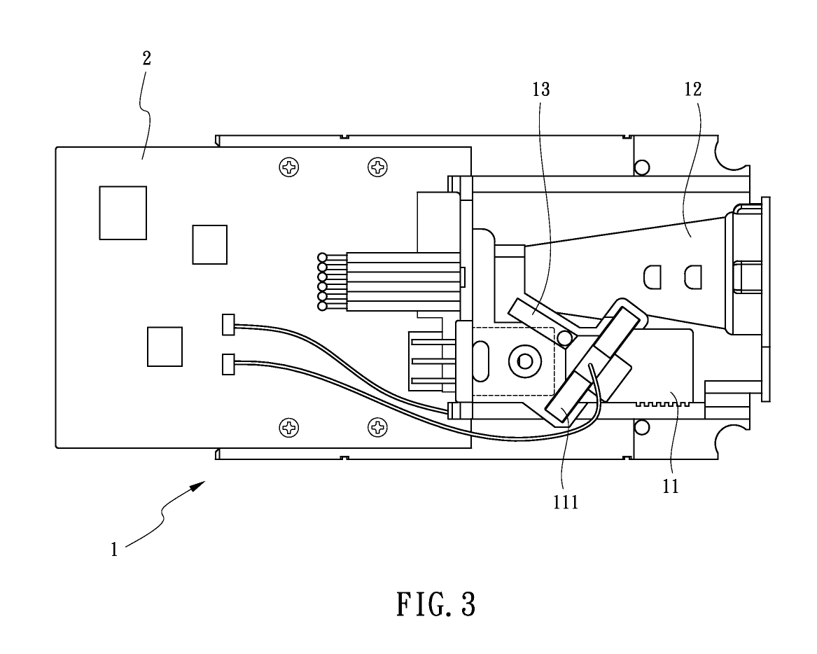

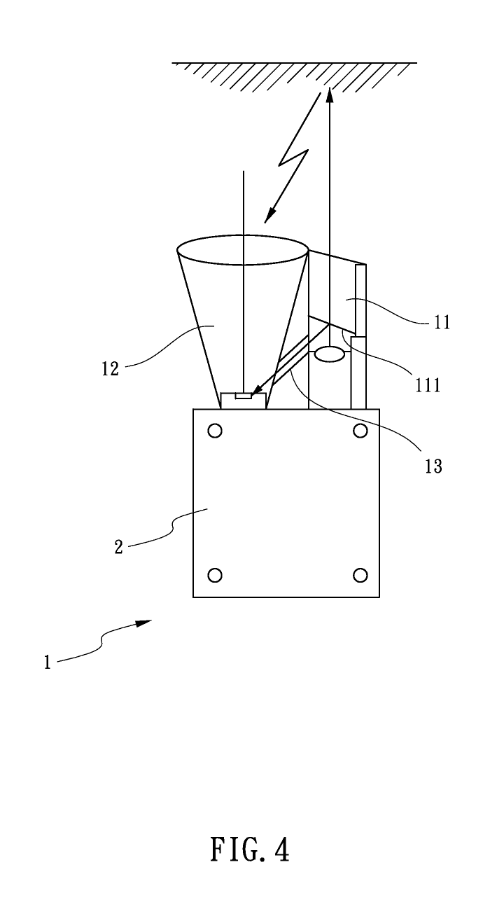

Referring to FIGS. 1-4, a laser rangefinder with single shutter in accordance with the present invention comprises a body 1 and a laser-radiating board 2. The body 1 has a transmitting gateway 11 and a receiving gateway 12 defined in the inside thereof The transmitting gateway 11 and the receiving gateway 12 pass through the body 1. The transmitting gateway 11 is parallel with the receiving gateway 12 (the transmitting gateway 11 is inclined shape in the embodiments of the present invention, and it might be a curve shape in the embodiments being not shown in the present invention). A shutter 111 is mounted on the transmitting gateway 11. The shutter 111 is located at the middle of the transmitting gateway 11. Referring to FIGS. 2-3, the laser-radiating board 2 is mounted to one end of the body 1 and corresponding to the transmitting gateway 11 and the receiving gateway 12. The laser-radiating board 2 can emit a laser beam to an object via the transmitting gateway 11 when the shutter 111 is opened. To close the shutter 111 or to open the shutter 111 is used to interdict the laser beam from the laser-radiating board 2 or not (the operation of the laser-radiating board 2 and the operation of the shutter 111 are well-known in the relevant field so that they are not further described).

Referring to FIGS. 2-3, the body 1 has an adjusting gateway 13. The adjusting gateway 13 communicates with the transmitting gateway 11 and the receiving gateway 12. The adjusting gateway 13 is placed obliquely relative to either the transmitting gateway 11 or the receiving gateway 12. The receiving gateway 12 might be formed as a mat structure, a rugged structure, an optical fiber structure or other light guiding structures. Under this arrangement, the laser beam from the laser-radiating board 2 is emitted to the object via the transmitting gateway 11 and the shutter 111 (before the laser beam goes to the object, the laser beam is reached to the shutter 111 at first, and then reflected by the shutter 111 to the adjusting gateway 13, thereafter the laser beam goes through the adjusting gateway 13 to the laser-radiating board 2 and the laser-radiating board 2 calculates a reference distance from the distance-operating database). When the laser beam travels to the object, the laser beam is reflected back to the receiving gateway 12 by the object and the laser beam goes through the receiving gateway 12 to the laser-radiating board 2, thereafter the laser-radiating board 2 calculates an actual distance from the laser rangefinder with single shutter to the object.

Furthermore, when the shutter 111 opens, the adjusting gateway 13 prevents the laser beam in the transmitting gateway 11 from scattering to the laser-radiating board 2 to interfere in the operating of the laser-radiating board 2; when the shutter 111 closes, the laser beam is reflected by the shutter 111 to the laser-radiating board 2 via the adjusting gateway 13 so that the laser-radiating board 2 calculates the reference distance from the distance-operating database. Due to the design of the adjusting gateway 13, when the laser beam is reflected into the receiving gateway 12 by the object, the adjusting gateway 13 prevents the outside noise from going into the laser-radiating board 2 so that only the laser beam reflected by the object goes into the laser-radiating board 2 and the laser-radiating board 2 calculates the actual distance from the laser rangefinder with single shutter to the object via the trip of the laser beam. The design of the adjusting gateway 13 is an important issue and is shown as following:

First, a thread with a mat or a rugged structure is formed on the inside wall of the adjusting gateway 13 for preventing the outside noise from going into the laser-radiating board 2;

Second, a light guiding structure is formed on the inside wall of the adjusting gateway 13; and

Third, an optical fiber structure which has a predefined reflecting surface is formed on the inside wall of the adjusting gateway 13.

Therefore, the adjusting gateway 13 not only guides the laser beam to the laser-radiating board 2 for calculating the distance-operating data, but also reduces the outside noise caused by the temperature effect from the laser-radiating board 2 or the error caused by the long-term using elements of the laser rangefinder with single shutter so as to improve the precision of the laser rangefinder with single shutter.

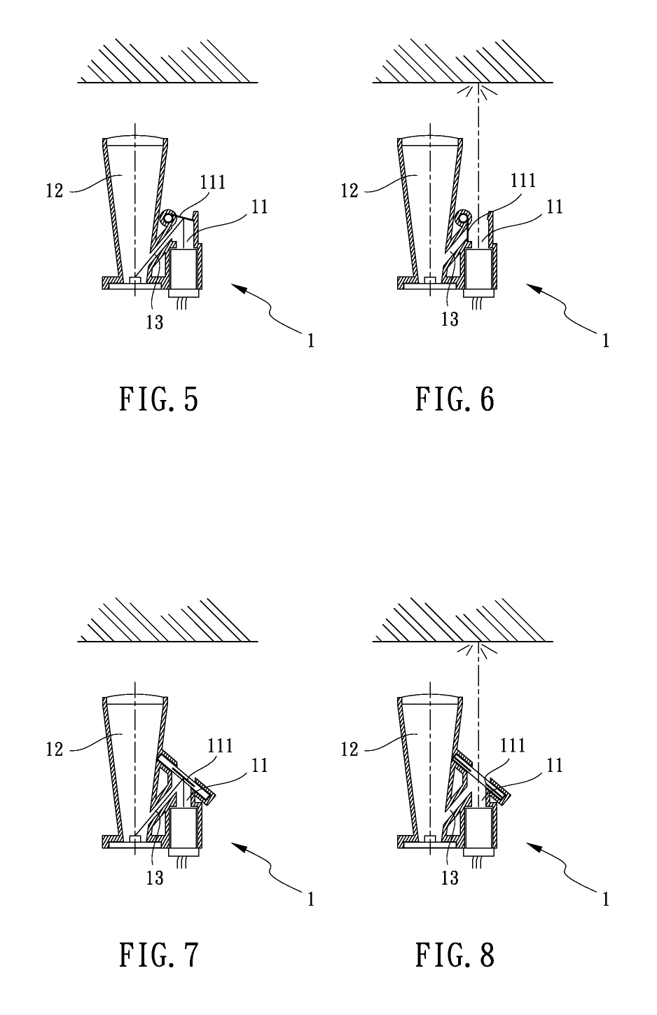

Referring to FIGS. 5-6, the shutter 111 is operated by pivoting action as shown in the second embodiment of the present invention; referring to FIGS. 7-8, the shutter 111 is operated by sliding action as shown in the third embodiment of the present invention. Although the invention has been explained in relation to its preferred embodiment, it is to be understood that many other possible modifications and variations can be made without departing from the spirit and scope of the invention as hereinafter claimed.

What is claimed is:

1. A laser rangefinder with single shutter comprising a body and a laser-radiating board, the body having a transmitting gateway and a receiving gateway defined inside thereof, the transmitting gateway being parallel to the receiving gateway, a shutter mounted on the transmitting gateway, the body having an adjusting gateway, the adjusting gateway communicates with the transmitting gateway and the receiving gateway, the laser-radiating board mounted to one end of the body and corresponding to the transmitting gateway and the receiving gateway;
wherein the laser beam from the laser-radiating board is emitted to the object via the transmitting gateway and the shutter; when the laser beam travels to the object, the laser beam is reflected back to the receiving gateway by the object and the laser beam goes through the receiving gateway to the laser-radiating board, thereafter the laser-radiating board calculates an actual distance from the laser rangefinder with single shutter to the object; when the shutter opens, the adjusting gateway prevents the laser beam in the transmitting gateway from scattering to the laser-radiating board to interfere in the operating of the laser-radiating board; when the shutter closes, the laser beam is reflected by the shutter to the laser-radiating board via the adjusting gateway so that the laser-radiating board calculates the reference distance from the distance-operating database.

2. The laser rangefinder with single shutter as claimed in claim 1, wherein to close the shutter or to open the shutter is used to interdict the laser beam from the laser-radiating board or not.

3. The laser rangefinder with single shutter as claimed in claim 1, wherein a mat structure is formed on the inside wall of the adjusting gateway.

4. The laser rangefinder with single shutter as claimed in claim 1, wherein a rugged structure is formed on the inside wall of the adjusting gateway.

5. The laser rangefinder with single shutter as claimed in claim 1, wherein a thread structure is formed on the inside wall of the adjusting gateway.

6. The laser rangefinder with single shutter as claimed in claim 3, wherein an optical fiber structure or other light guiding structure is formed on the inside wall of the adjusting gateway.

7. The laser rangefinder with single shutter as claimed in claim 4, wherein the transmitting gateway is curve shape.

8. The laser rangefinder with single shutter as claimed in claim 4, wherein an optical fiber structure which has a predefined reflecting surface is formed on the inside wall of the adjusting gateway.

9. The laser rangefinder with single shutter as claimed in claim 5, wherein the optical fiber structure which has the predefined reflecting surface is formed on the inside wall of the adjusting gateway.
